(19) United States
(12) Patent Application Publication
(10) Pub. No.: US 2015/0171746 A1
(43) Pub. Date: Jun. 18, 2015

(54) BUCK TYPE DC-TO-DC CONVERTER AND METHOD OF OPERATING THE SAME

(71) Applicant: National Tsing Hua University, Hsinchu City (TW)

(72) Inventors: Ching-Tsai Pan, Hsinchu City (TW); Jing-Hao Wang, Hsinchu City (TW)

(21) Appl. No.: 14/326,903

(22) Filed: Jul. 9, 2014

(30) Foreign Application Priority Data
Dec. 16, 2013 (TW) 102146366

(51) Int. Cl. H02M 3/156

(52) U.S. Cl. CPC H02M 3/156

(57) ABSTRACT

A buck-type DC-to-DC converter and a method of operating the same are provided. The converter includes: an active switch electrically connected to an input power source having an input voltage; a diode having two terminals electrically connected to the active switch and the input power source, respectively; a resonant circuit connected in parallel with the diode and including a capacitor and a resonant inductor connected in series with the capacitor; and an output inductor electrically connected to the resonant circuit and connected in series with a load electrically connected to the resonant circuit. The active switch and the diode are switched in an on-state or an off-state according to different working modes. The active switch is switched from the off-state to the on-state by a switching voltage less than the input voltage. The diode is switched from the on-state to the off-state by a switching current equal to zero.

### BACKGROUND OF THE INVENTION

1. Field of the Invention

The present invention relates to DC converting techniques, and, more particularly, to a buck type DC-to-DC converter and a method of operating the same.

2. Description of Related Art

Basic buck converters have been widely used due to various advantages, including a small number of components, small size, high reliability, low cost, easy to control and so on. However, the active switch of a basic buck converter is hard to switch and thus generates high switching voltage. Furthermore, diodes of the basic buck converter will generate a reverse recovery current during switching, thus causing a great switching loss.

In the dimming of a load that is an active load (e.g., an LED), the basic buck converter also has the shortcoming of narrow dimming range of the duty cycle. When the output voltage of the basic buck converter is less than the forward voltage of the load, energy of the basic buck converter cannot be transferred to the load.

FIG. 1 is a circuit diagram of a basic buck converter 1 according to the prior art. The basic buck converter 1 comprises an active switch SW, a diode D_{b}, an output inductor L, and an output capacitor C. The active switch SW is electrically connected to an input power source having an input voltage Vᵢₙ. The two terminals of the diode D_{b} are electrically connected to the active switch SW and the input power source, respectively. The output inductor L is electrically connected with the active switch SW and the diode D_{b}. The two terminals of the output capacitor C are electrically connected to the output inductor L and the diode D_{b}, respectively. A load with a resistance Rₒ is connected in parallel with the output capacitor C. The voltages at the active switch SW, the diode D_{b}, the output inductor L, the output capacitor C, and the two terminals of the load are voltage V_{SW}, voltage V_{Db}, voltage V_{L}, voltage V_{C}, and output voltage Vₒ, respectively.

FIG. 2 illustrate waveforms of voltages and currents of some components of the basic buck converter according to the prior art. As shown in FIGS. 1 and 2, in each period T of a pulse width modulation signal V_{PWM} of the basic buck converter 1, when the basic buck converter 1 operates in a first working mode M₁, the active switch SW and the diode D_{b} are switched on-state and off-state, respectively. When the basic buck converter 1 operates in a second working mode M₂, the active switch SW and the diode D_{b} are switched in an off-state and an on-state, respectively.

When the active switch SW is switched between the on-state and the off-state, the switching voltage V_{SW1} of the active switch SW is equal to the input voltage Vᵢₙ, and thus the switching voltage V_{SW1} will cause a great amount of switching loss. Moreover, when the diode D_{b} is switched between the on-state and the off-state, the switching current I_{Db1} of the diode D_{b} is equal to the reverse recovery current, so the switching current I_{Db1} will also cause an additional energy loss. Thus, if the active switch SW is carrying out high-frequency switching, the conversion efficiency of the basic buck converter 1 will become low.

In addition, when the basic buck converter 1 is applied to an active load such as an LED (not shown), the output voltage Vₒ has to be greater than the forward voltage (VF) of the load in order for the energy to be transferred to the load. If the duty cycle of the active switch SW is used to adjust the current of the load (e.g., an LED) from zero to the rated current, then the available adjustable range of the duty cycle is relatively narrow, which will cause poor dimming resolution. If the dimming resolution is to be improved, then an additional dimming circuit or control method has to be adopted to increase the dimming range. However, this may increase the complexity and cost of the circuit of the converter, and may even reduce efficiency.

Therefore, there is a need for a solution that addresses the aforementioned issues in the prior art.

### SUMMARY OF THE INVENTION

The present invention provides a buck-type DC-to-DC converter, which includes: an active switch electrically connected to an input power source having an input voltage; a diode having two terminals electrically connected to the active switch and the input power source, respectively; a resonant circuit connected in parallel with the diode and including a capacitor and a resonant inductor connected in series with the capacitor; and an output inductor electrically connected to the resonant circuit and connected in series with a load electrically connected to the resonant circuit, wherein the active switch and the diode are switched in an on-state or an off-state according to different working modes, the active switch is switched from the off-state to the on-state by a switching voltage less than the input voltage, and the diode is switched from the on-state to the off-state by a switching current equal to zero.

The present invention also provides a method of operating a buck-type DC-to-DC converter, comprising: providing a buck-type DC-to-DC converter including an active switch electrically connected to an input power source having an input voltage, a diode, a resonant circuit connected in parallel with the diode and including a capacitor and a resonant inductor connected in series with the capacitor, and an output inductor electrically connected to the resonant circuit and connected in series with a load electrically connected to the resonant circuit; and switching the active switch and the diode in an on-state or an off-state according to different working modes, wherein the active switch switched from the off-state to the on-state by a switching voltage less than the input voltage, and the diode is switched from the on-state to the off-state by and a switching current equal to zero.

From the above, it can be understood that the buck-type DC-to-DC converter and the method of the same according to the present invention entail connecting the diode in parallel with a resonant circuit having a capacitor and a resonant inductor connected in series with the capacitor, and connecting the load in series with an output inductor, to allow the switching voltage of the active switch to be less than the input voltage, and to allow the switching current of the diode to be equal to zero.

Therefore, the present invention not only retains the various advantages, such as a small number of components, small size, high reliability, low cost, easy to control and so on of the conventional basic buck converter, but also allows the active switch to perform low-voltage switching to reduce its switching loss, and allows the diode DC to achieve zero-current switching effect to reduce the energy loss caused by its reverse recovery current. Besides, it also increases conversion efficiency and duty cycle utilization of the converter, and enhances the dimming resolution of an active load (e.g. a LED).

### BRIEF DESCRIPTION OF THE DRAWINGS

The present invention can be more fully understood by reading the following detailed description of the preferred embodiments, with reference made to the accompanying drawings, wherein:

FIG. 1 is a circuit diagram of a basic buck converter according to the prior art;

FIG. 2 illustrates waveforms of voltages and currents of some components of the basic buck converter according to the prior art;

FIG. 3 is a circuit diagram of a buck-type DC-to-DC converter in accordance with the present invention;

FIGS. 4A and 4B illustrate a method of operating the buck-type DC-to-DC converter according to the present invention in a first working mode;

FIGS. 5A and 5B illustrate a method of operating the buck-type DC-to-DC converter according to the present invention in a second working mode;

FIG. 6 illustrates a method of operating the buck-type DC-to-DC converter according to the present invention in a third working mode;

FIG. 7 illustrates waveforms of voltages and currents of some components of the buck-type DC-to-DC converter according to the present invention;

FIG. 8 is a parameter table of component specifications of the buck-type DC-to-DC converter according to the present invention and the basic buck converter according to the prior art; and

FIG. 9 depicts curves of duty cycle versus output current for the buck-type DC-to-DC converter according to the present invention and the basic buck converter according to the prior art based on the parameter table shown in FIG. 8.

### DETAILED DESCRIPTION OF THE EMBODIMENTS

The present invention is described by the following specific embodiments. Those with ordinary skills in the arts can readily understand other advantages and functions of the present invention after reading the disclosure of this specification.

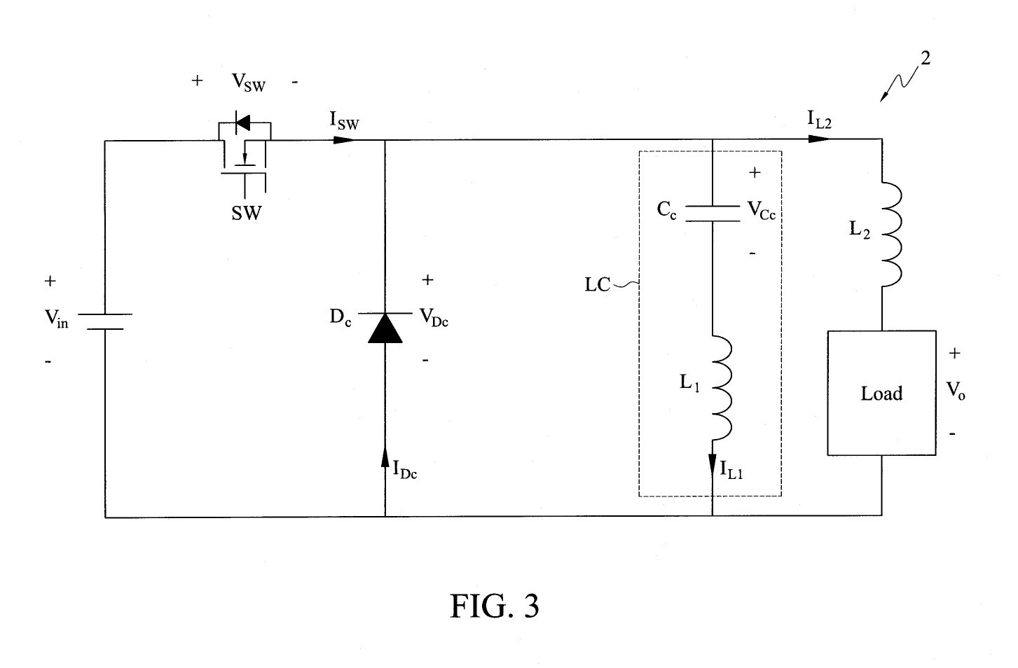

FIG. 3 is a circuit diagram of a buck-type DC-to-DC converter 2 in accordance with the present invention. The buck-type DC-to-DC converter 2 includes an active switch SW, a diode D_{C}, a resonant circuit LC, and an output inductor L₂. The buck-type DC-to-DC converter 2 may also include or be connected to an input power source having an input voltage Vᵢₙ.

The active switch SW can be a metal-oxide-semiconductor field-effect transistor (MOSFET), and is electrically connected to the input power source. The two terminals of the diode D_{C} are connected to the active switch SW and the input power source, respectively. The resonant circuit LC is connected in parallel with the diode D_{C}, and includes a capacitor (e.g., a clamp capacitor Cc) and a resonant inductor L₁ connected in series with the capacitor. The output inductor L₂ is connected in series with a load, and the output inductor L₂ and the load are electrically connected to the resonant circuit LC. The voltages of the active switch SW, the diode D_{C}, the clamp capacitor Cc and two terminals of the load are voltage V_{SW}, voltage V_{Dc}, voltage V_{Cc}, and output voltage Vₒ, respectively.

The active switch SW and the diode D_{C} are switched between an on-state and an off-state according to different working modes. The switching voltage at the time when the active switch SW is switched from the off-state to the on-state is less than the input voltage Vᵢₙ, or equal to the input voltage Vᵢₙ subtracted by the output voltage Vₒ. The switching current at the time when the diode D_{C} is switched from the on-state to the off-state is equal to zero.

The active switch SW may adjust the magnitude of the output power of the input power source, or the output current I_{L2} passing through the output inductor L₂, or the output voltage Vo at the two terminals of the load by changing its conduction interval, switching frequency or duty cycle. Furthermore, the resonant circuit LC may also adjust the time constant for circuit actuation of the resonant circuit LC by changing the capacitance of the clamp capacitor Cc or the inductance of the resonant inductor L₁. In addition, the output inductor L2 may also adjust the output current I_{L2} passing through the output inductor L₂ or the ripple size of the output voltage Vₒ at the two terminals of the load by changing its inductance.

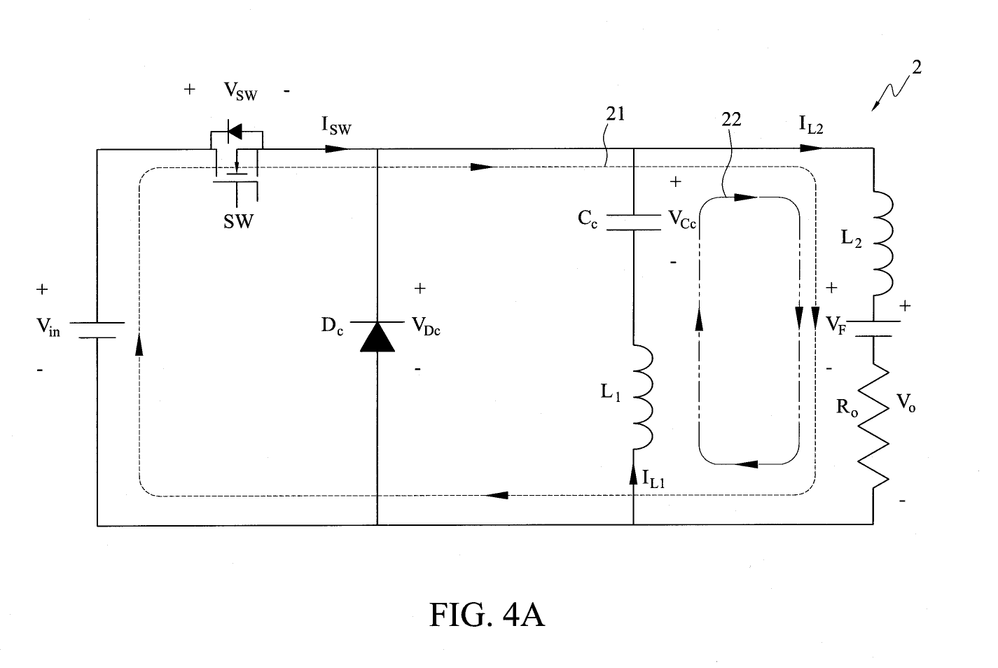

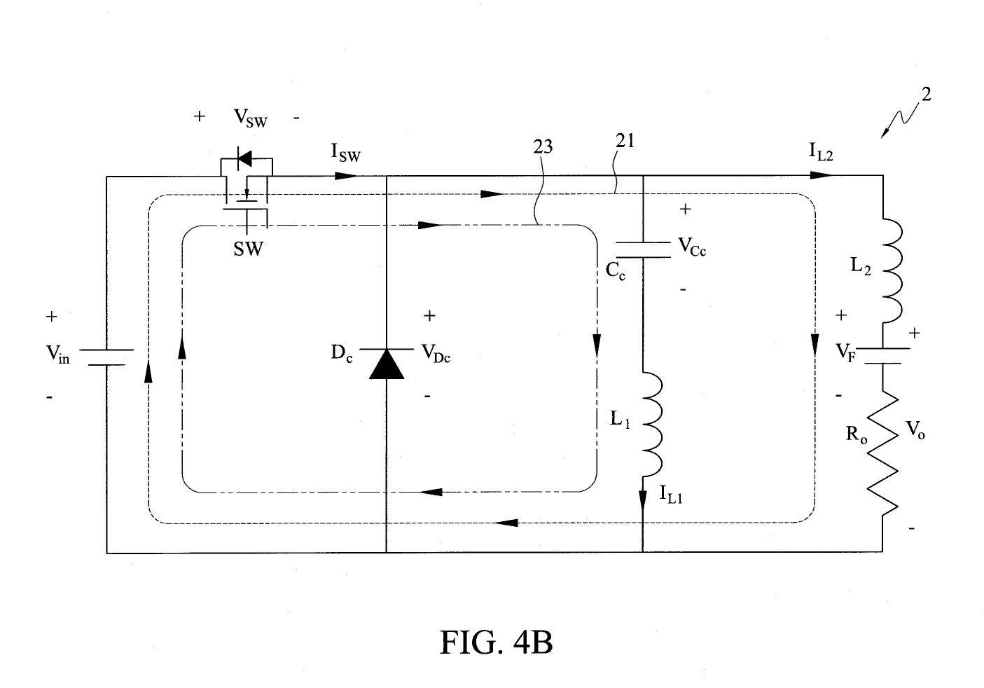

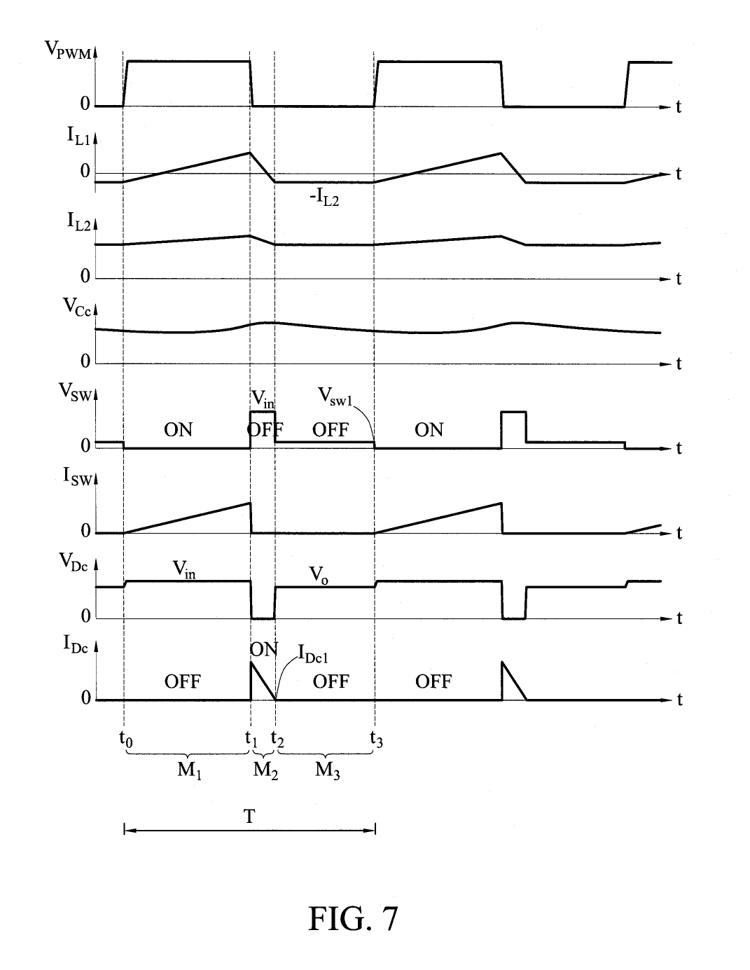

FIGS. 4A and 4B illustrate a method of operating the buck-type DC-to-DC converter according to the present invention in a first working mode. Also refer to FIG. 7 at the same time.

During time t₀ to time t₁ of the period T of the pulse width modulation signal V_{PWM} of the buck-type DC-to-DC converter 2, when the buck-type DC-to-DC converter 2 is operating in a first working mode M₁, the active switch SW is switched in the on-state, and the diode D_{C} remains switched in the off-state to allow currents to flow through a loop 21 and a loop 22, such that the input power source having the input voltage Vᵢₙ allows the clamp capacitor Cc to resonate with the resonant inductor L₁, thereby changing the current I_{L1} of the resonant inductor L₁ from flowing in a reverse direction (loop 22 of FIG. 4A) to a forward direction (loop 23 of FIG. 4B), and allowing the energy of the input power source to be transferred to the output inductor L₂, the load, the clamp capacitor Cc, and the resonant inductor L₁. In an embodiment, the load may be an active load (e.g., an LED) having a forward bias V_{F} and a resistance Rₒ.

When the active switch SW is switched from the on-state to the off-state, the buck-type DC-to-DC converter 2 changes from the first working mode M₁ to a second working mode M₂.

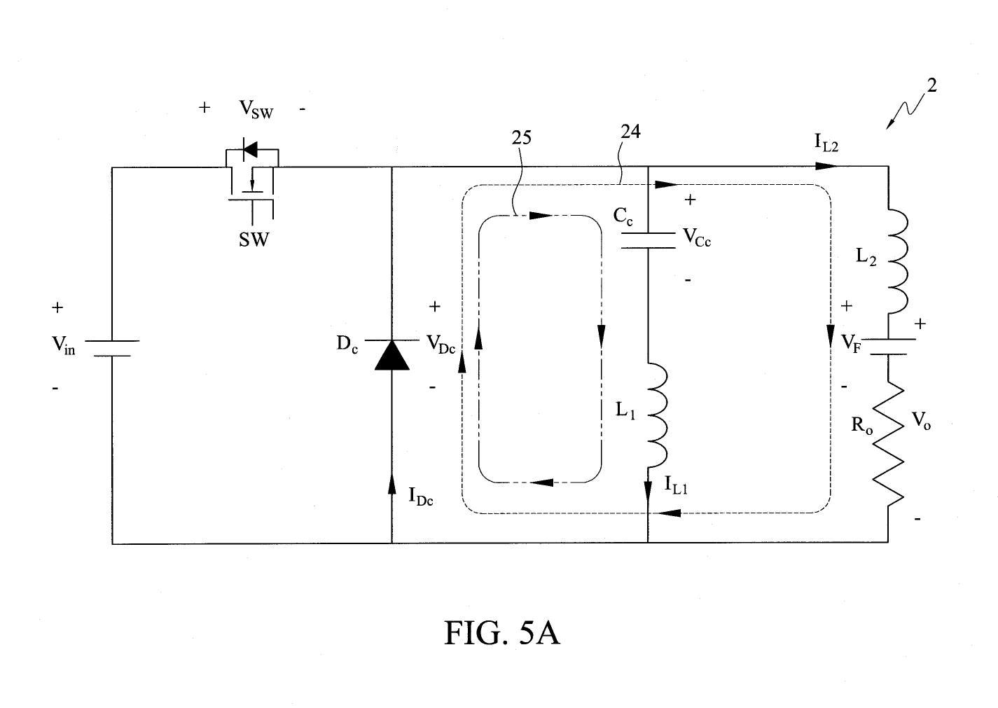

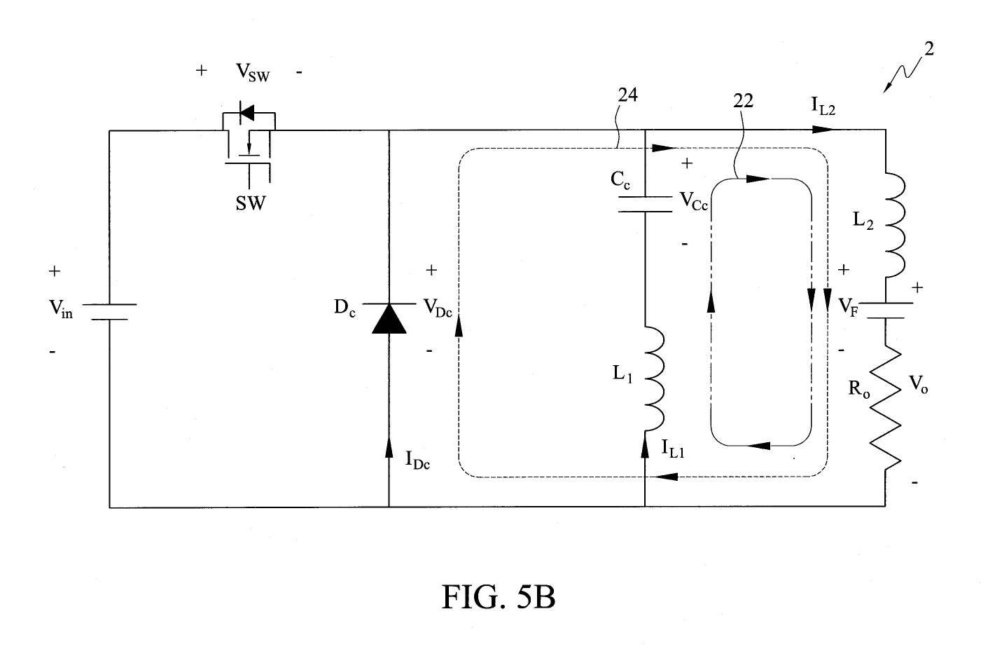

FIGS. 5A and 5B illustrate the method of operating the buck-type DC-to-DC converter according to the present invention in a second working mode. Also refer to FIG. 7 at the same time.

During time t₁ to time t₂ of the period T of the pulse width modulation signal V_{PWM} of the buck-type DC-to-DC converter 2, when the buck-type DC-to-DC converter 2 is operating in the second working mode M₂, the active switch SW is switched in the off-state, and the diode D_{C} is switched in the on-state to allow currents to flow through a loop 24 and a loop 25, allowing the clamp capacitor Cc to resonate with the resonant inductor L₁, thereby changing the current of the resonant inductor L₁ to flow from a forward direction (loop 25 of FIG. 5A) to a reverse direction (loop 22 of FIG. 5B), and allowing the energy stored in the output inductor L₂ to be released to the load with forward bias V_{F} and resistance Rₒ.

When the current I_{L1} of the resonant inductor L₁ is equal to the current I_{L2} of the output inductor L₂, the buck-type DC-to-DC converter 2 changes from the second working mode M₂ to a third working mode M₃.

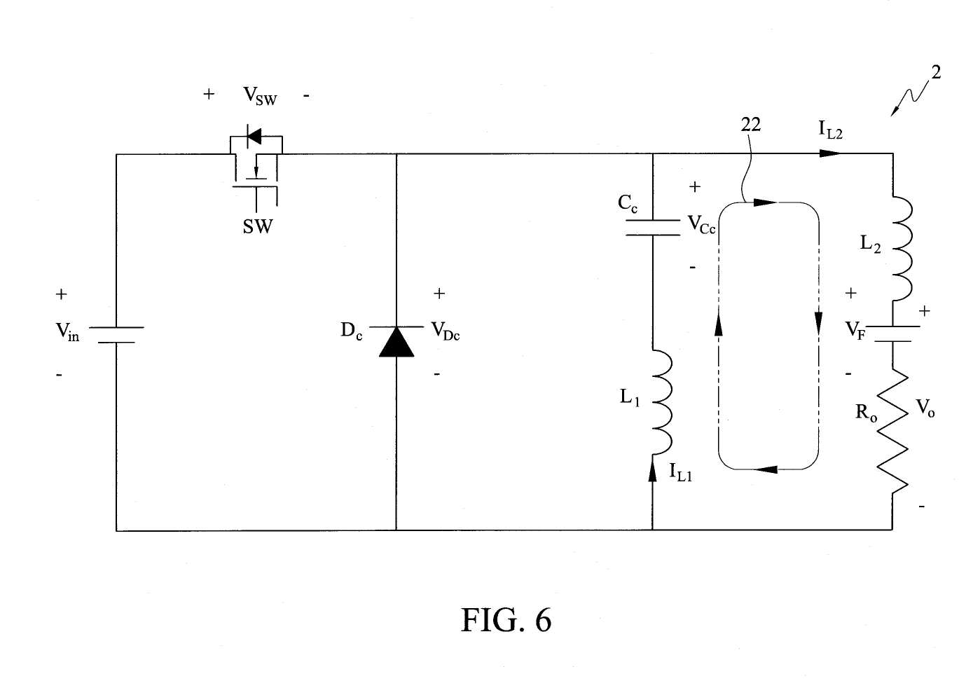

FIG. 6 illustrates the method of operating the buck-type DC-to-DC converter according to the present invention in a third working mode. Also refer to FIG. 7 at the same time.

During time t₂ to time t₃ of the period T of the pulse width modulation signal V_{PWM} of the buck-type DC-to-DC converter 2, when the buck-type DC-to-DC converter 2 is operating in the third working mode M₃, the active switch SW remains switched in the off-state, and the diode D_{C} is switched in the off-state to allow current to flow through loop 22, allowing the clamp capacitor Cc and the resonant inductor L₁ to resonate with the output inductor L₂, thus releasing the energy stored in the clamp capacitor Cc and the resonant inductor L₁ to the load with forward bias V_{F} and resistance Rₒ.

When the active switch SW is switched in the on-state again, the active switch SW finishes switching for one period T, and the buck-type DC-to-DC converter 2 continues to operate from the first working mode M₁ to the third working mode M₃ of the next period.

FIG. 7 depicts waveforms of voltages and currents of some components of the buck-type DC-to-DC converter according to the present invention. As shown in the waveform of voltage V_{SW} in FIG. 7, when the active switch SW is switched from the off-state in the third working mode M₃ of the period T to the on-state in the first working mode M₁ of the next period T, the switching voltage V_{SW1} of the active switch SW is less than the input voltage Vᵢₙ, or equal to the input voltage Vᵢₙ subtracted by the output voltage Vₒ. In the waveform of the current I_{Dc} in FIG. 7, the switching current I_{Dc1} is equal to zero when the diode D_{C} is switched from the on-state of the second working mode M₂ of the period T to the off-state of the third working mode M₃.

Therefore, the present invention allows the active switch SW to perform low-voltage switching, and thus reducing its switching loss. Furthermore, the diode DC achieves zero-current switching effect, thus reducing the energy loss caused by its reverse recovery current.

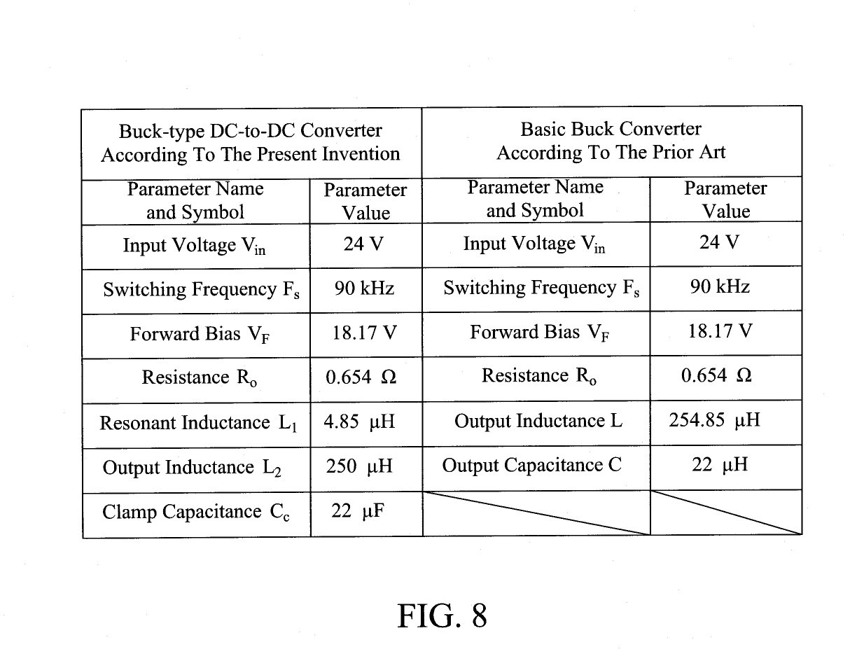

FIG. 8 is a parameter table of component specifications of the buck-type DC-to-DC converter according to the present invention and the basic buck converter according to the prior art.

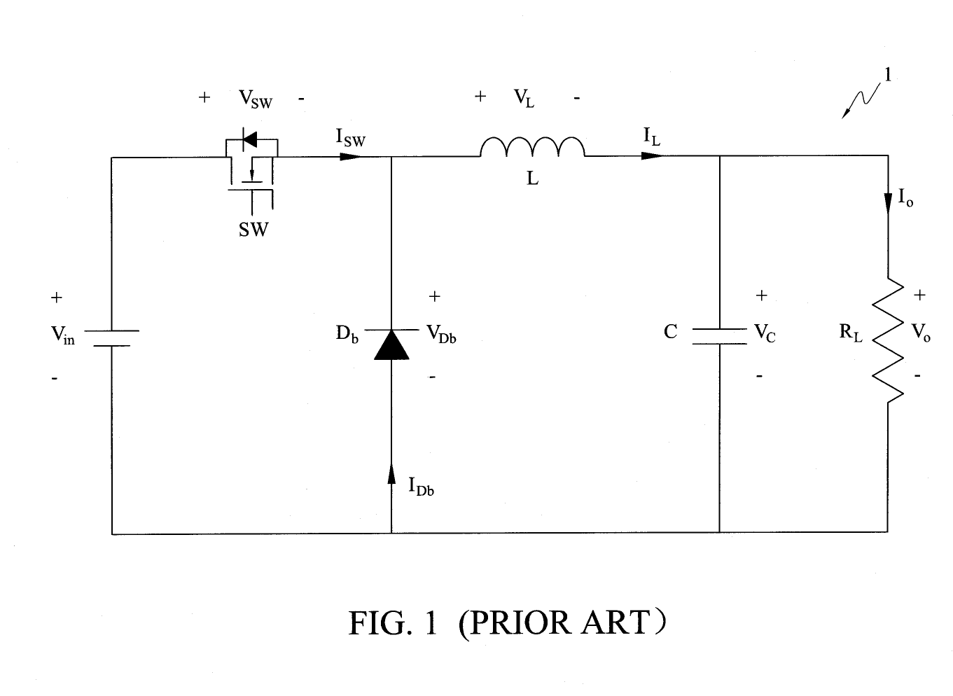

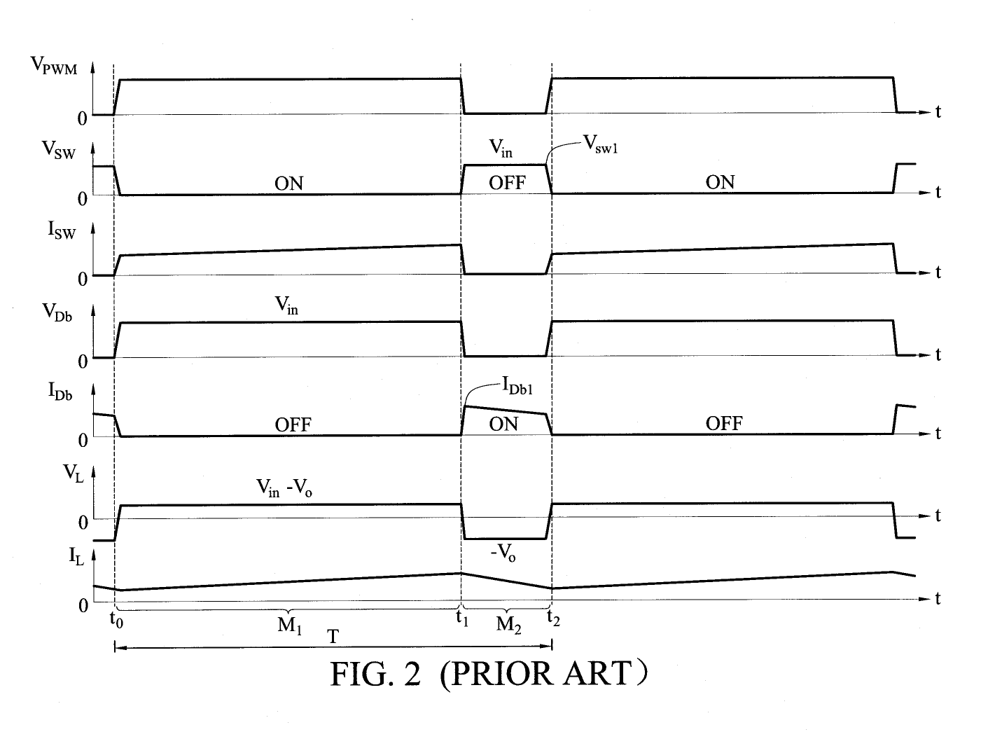

The parameter values of the input voltage Vᵢₙ, the switching frequency Fₛ, the forward bias V_{F} and the resistance Rₒ for both the buck-type DC-to-DC converter of FIGS. 4A to 6 and the prior-art basic buck converter of FIG. 1, and the loads for the present invention and the prior art can both be active loads (e.g., LEDs) with the forward bias V_{F} and the resistance Rₒ as in FIG. 4A above.

The present invention differs from the prior art in that the buck-type DC-to-DC converter according to the present invention has a resonant inductor L1 with a parameter value of 4.85 μH, an output inductor L2 with a parameter value of 250 μH, and a clamp capacitor Cc with a parameter value of 22 μF, while the basic buck converter according to the prior art has an output inductor L with a parameter value of 254.85 μH and an output capacitor C with a parameter value of 22 μF.

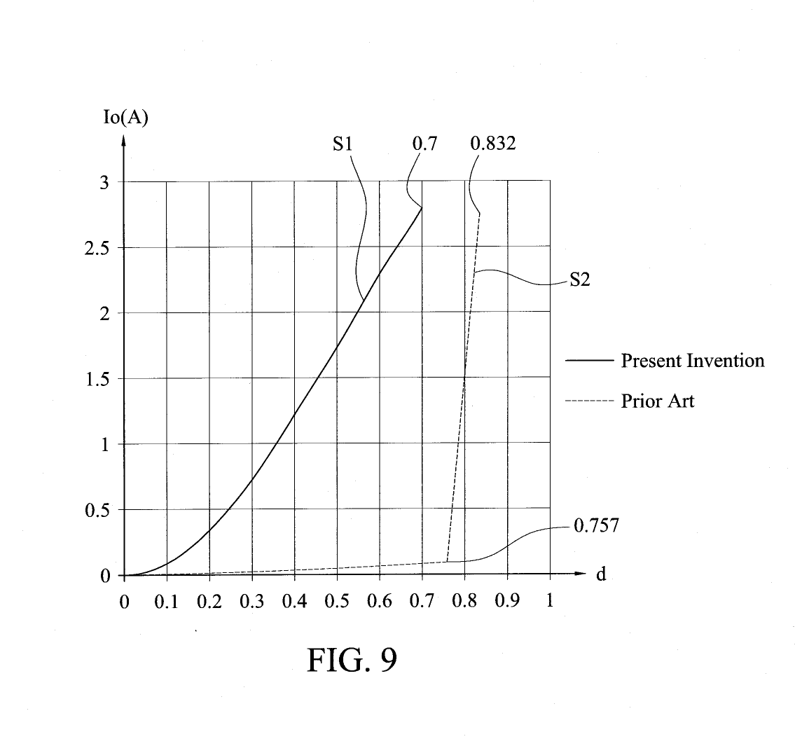

FIG. 9 depicts curves of duty cycle versus output current for the buck-type DC-to-DC converter according to the present invention and the basic buck converter according to prior art based on the parameter table shown in FIG. 8.

In the case that the loads for the present invention and the prior art are both active loads (e.g., LEDs) with the forward bias V_{F} and the resistance Rₒ as in FIG. 4A above, when one wishes to increase the output current Iₒ (or I_{L2}) from zero to the maximum drive current overload of approximately 2.75 amps, the adjustable range of the duty cycle d of a curve S1 for the present invention is approximately 0.7 (from 0 to 0.7), but the adjustable range of the duty cycle d of a curve S2 for the prior art is only approximately 0.075 (from 0.757 to 0.832). Therefore, compared to the basic buck converter of the prior art, the buck-type DC-to-DC converter of the present invention has a higher duty-cycle adjustable range, and is more suitable for the dimming of active loads (e.g. LEDs).

From the above, it can be understood that the buck-type DC-to-DC converter and the method of operating the same according to the present invention entails connecting the diode in parallel with a resonant circuit having a capacitor and a resonant inductor connected in series with the capacitor, and connecting the load in series with an output inductor to allow the switching voltage of the active switch to be less than the input voltage, and to allow the switching current of the diode to be equal to zero.

Therefore, the present invention not only retains the various advantages such as small number of components, small size, high reliability, low cost, easy to control and so on of the conventional basic buck converter, but also allows the active switch to perform low-voltage switching to reduce its switching loss, and allows the diode DC to achieve zero-current switching effect to reduce the energy loss caused by its reverse recovery current. Meanwhile, it also increases conversion efficiency and duty cycle utilization of the converter, and enhances the dimming resolution of an active load (e.g. a LED).

The above embodiments are only used to illustrate the principles of the present invention, and should not be construed as to limit the present invention in any way. The above embodiments can be modified by those with ordinary skill in the art without departing from the scope of the present invention as defined in the following appended claims.

What is claimed is:

1. A buck-type DC-to-DC converter, comprising:
an active switch electrically connected to an input power source having an input voltage;
a diode having two terminals electrically connected to the active switch and the input power source, respectively;
a resonant circuit connected in parallel with the diode and including a capacitor and a resonant inductor connected in series with the capacitor; and
an output inductor electrically connected to the resonant circuit and connected in series with a load electrically connected to the resonant circuit,
wherein the active switch and the diode are switched in an on-state or an off-state according to different working modes, the active switch is switched from the off-state to the on-state by a switching voltage less than the input voltage, and the diode is switched from the on-state to the off-state by a switching current equal to zero.

2. The buck-type DC-to-DC converter of claim 1, wherein the switching voltage is equal to the input voltage subtracted by an output voltage of the load.

3. The buck-type DC-to-DC converter of claim 1, wherein the active switch adjusts, by changing a conduction interval, switching frequency or duty cycle thereof, an output power of the input power source, an output current passing through the output inductor, or an output voltage of the load.

4. The buck-type DC-to-DC converter of claim 1, wherein the resonant circuit adjusts a time constant of the resonant circuit by changing a capacitance of the capacitor or an inductance of the resonant inductor.

5. The buck-type DC-to-DC converter of claim 1, wherein the output inductor adjusts, by changing an inductance thereof, an output current passing through the output inductor or a ripple size of an output voltage of the load.

6. The buck-type DC-to-DC converter of claim 1, wherein the load is an active load, an output current of the load is from 0 to 2.75 amps, an adjustable range of a duty cycle of the active switch is 0.7.

7. A method of operating a buck-type DC-to-DC converter, comprising:
providing a buck-type DC-to-DC converter including an active switch electrically connected to an input power source having an input voltage, a diode, a resonant circuit connected in parallel with the diode and including a capacitor and a resonant inductor connected in series with the capacitor, and an output inductor electrically connected to the resonant circuit and connected in series with a load electrically connected to the resonant circuit; and
switching the active switch and the diode in an on-state or an off-state according to different working modes,
wherein the active switch switched from the off-state to the on-state by a switching voltage less than the input voltage, and the diode is switched from the on-state to the off-state by and a switching current equal to zero.

8. The method of claim 7, wherein the working modes include a first working mode, and the method includes: switching the active switch in the on-state, and allowing the diode to remain in the off-state, such that the input power source allows the capacitor to resonate with the resonant inductor, and in turn changes a current of the resonant inductor to flow from a reverse direction to a forward direction so as to allow energy of the input power source to be transferred to the output inductor, the load, the capacitor, and the resonant inductor.

9. The method of claim 8, wherein the working modes include a second working mode, and the method includes: switching the active switch to the off-state, and switching the diode to the on-state, to allow the capacitor to resonate with the resonant inductor, so as to change a current of the resonant inductor to flow from a forward direction to a reverse direction and allow energy stored in the output inductor to be released to the load.

10. The method of claim 9, wherein the working modes include a third working mode, and the method includes: allowing the active switch to remain in the off-state, and switching the diode to the off-state, to allow the capacitor and the resonant inductor to resonate with the output inductor, so as to release the energy stored in the capacitor and the resonant inductor to the load.
